(19) United States
(12) Patent Application Publication
(10) Pub. No.: US 2006/0248115 A1
(43) Pub. Date: Nov. 2, 2006

(54) Method for managing and representing the memory content on the user surface of a data processing terminal and/or communication terminal

(75) Inventors: Andreas Schmidt, Braunschweig (DE); Markus Trauberg, Velchede (DE)

Correspondence Address: YOUNG & THOMPSON, 745 SOUTH 23RD STREET, 2ND FLOOR, ARLINGTON, VA, 22202, US

(73) Assignee: SIEMENS AKTIENGESELLSCHAFT, Munchen (DE)

(21) Appl. No.: 10/553,796

(22) PCT Filed: Jan. 26, 2004
(86) PCT No.: PCT/EP04/00625

§ 371 Date: Oct. 18, 2005

(30) Foreign Application Priority Data
Apr. 30, 2003 (DE) 103 19 588.2

(51) Int. Cl. G06F 17/00

(52) U.S. Cl. 707/104.1

(57) ABSTRACT

The invention relates to a method for managing and representing the memory content or a memory area of a data processing terminal and/or communication terminal or for representing the memory content or a memory area on the user surface (1) of a data processing terminal and/or communication terminal. According to the inventive method, the name or title of at least one user data object (3) contained in a DRM file (2) is represented directly on the user surface (1) of the data processing terminal and/or communication terminal together with the name or title of the DRM file (2) and/or the names and titles of other files (4) such as image files, audio files, or text files if available.

The invention relates to a method for managing and representing the memory content or a memory area of a data processing terminal and/or a communication terminal or for representing the memory content or a memory area on the user surface of a data processing terminal and/or of a communication terminal.

Data processing terminals and in many cases communication terminals too have at least one memory in which any given files or data objects can be stored. Mostly a visual presentation of the structure and of the content of this memory or of a memory area is made possible for the user by software. This reads in the necessary information relating to structure and content of the memory and presents it graphically on a user surface of the data processing terminal or of the communication terminal. The same applies to the dialogs for opening or for saving files. Here too information is displayed about the memory and the files stored in it. The display of the information mostly includes the name of the folder, the file name and the file type, which is either determined with reference to the file name extension or is read out from a corresponding information element in the file itself.

An application can be linked to a file type so that when a file is opened the corresponding application which is in a position to process the file is also started at the same time. Automatic transfer of the file to the corresponding application makes it possible to open the file in a convenient manner.

As well as the usual file formats for picture, audio or text files, file formats are also used which have an encrypted content and are subject to a method for management of rights, known as Digital Rights Management (DRM). When a file which has a DRM-protected content is activated, a corresponding application for processing the DRM file format is thus first started. This application, known as the DRM agent, evaluates the control information contained in the DRM file, checks whether the user has the right to use the DRM-protected object in the DRM file, encrypts the useful data object contained in the DRM file if necessary and passes this on to an application for processing the useful data object. For the user the presentation only shows the DRM file of the files present in the memory in this case. I.e. the usual presentation in accordance with the prior art does not provide any information about which type of file, the user data object, is contained in the DRM file, which name the file contained in the DRM file has or which rights are available for using the file contained in the DRM file.

This makes it very difficult for the user, in a view of the DRM files, to search explicitly for a user data object, since important information, such as the name, the type, the size or also usage rights linked to the object are not visible directly for example. The user must therefore either note the assignment between the user data object sought and the DRM file or he searches through the available DRM files to find the desired user data object.

I.e. in the prior art in a general view the user is only shown the files present in a memory or in an area of memory in the form of their name and type, with no distinction being made for example between “normal” files such as text, audio and video data, and DRM files, which in their turn can contain at least one user data object. To obtain information about the content of a DRM file, in accordance with the prior art, the user initially had to read in or open the DRM file with a DRM agent and evaluate it accordingly. Subsequently the DRM agent shows the relevant information of the user data object(s) contained in the DRM file in relation to type, name, and possibly rights connected with the user data object. Based on this information the user can decide whether he wishes to use the user data object contained in the DRM file or not. The disadvantage of this method is that it involves a great deal of effort as regards computing power and is inconvenient in respect of the increased time needed to operate it or to find specific user data objects The user is not also shown directly with the view of the different file formats, the user data object or objects of a DRM file instead of or in addition to this view. This makes the search for a specific user data object significantly longer since the user, if he lacks the knowledge of the exact position of the corresponding user data object, must open all DRM files to obtain a particular user data object.

The object of the present invention is to create a method for management or for presentation of the content of a memory or of a memory area on the user surface of a data processing terminal and/or of a communication terminal, in which the user is given a rapid and comprehensive overview of the entire contents of the memory or of the memory area.

This object is achieved by the object of the independent claims 1 and 12. Advantageous embodiments are the object of the subclaims.

With the inventive method the name or the title of at least one user data object contained in a DRM file is presented directly along with the name or the title of the DRM file and/or with the name or the title or other files, such as picture, audio or text files for example, on the user surface of the data processing terminal and/or of the communication terminal. This not only shows the user the names/titles of the files, but also the names/titles of the user data objects contained in the DRM files. When searching for specific user data objects, the user does not lose any time since he does not have to first read in or open the individual DRM files in order to reach the user data objects. The integration of the specific properties of DRM-protected objects into the application of a data processing terminal and/or communication terminal for management and presentation of a memory content or an area of memory is advantageous, with the particular property that the name or the title of the DRM-protected object is shown directly at the user interface, i.e. on the user surface of the data processing terminal and/or communication terminal. The parameters associated with the DRM-protected object available on the data processing terminal and/or communication terminal are evaluated and the results of the evaluation are presented graphically and/or as a text image at the user interface. The user data objects contained in a DRM file are presented and handled on one level with other files, for example text, picture or audio files. The file manager takes on the function of an object manager.

In the method the DRM file is opened in a first step and the underlying parameters such as name, type, size, etc., of the at least one user data object are read out. In a second step at least one of the parameters of the user data object previously read out is presented instead of or in addition to corresponding parameters such as name, type, size etc. of the DRM file on the user surface of the data processing terminal and/or of the communication terminal. At least the name/title of the user data object is presented. Further property parameters, such as type, size, etc. can be presented in addition to the name/title.

When the memory content or a memory area is called up, in addition to the property parameters,,especially the name/title of other files, such as for example picture, audio or text files, the content of the DRM files, the user data objects, is also presented automatically at the user interface. I.e the property parameters, especially the name/title of the user data objects are presented. This gives the user of a data processing terminal and/or of a communication terminal a direct complete overview of the contents of the memory or of a memory area of the corresponding device, including the user data objects of the DRM files.

It is especially advantageous if, in a further step, usage rights of the at least one user data object are sought, evaluated and presented in combination with at least the name/title and possibly with the remaining parameters of the corresponding DRM file or the corresponding user data object on the user surface of the data processing terminal and/or of the communication terminal. This gives the user an additional overview of the rights for using the individual user data objects. As well as the information, such as name, type or size of the user data objects, the user can see directly which user rights are linked to the user data object. This provides him with immediate information about the type of rights involved or of how many rights exist at all. He can recognize whether he has the right to use a user data object or not.

A method is preferred in which the parameters, especially name/title of the DRM file and/or the parameters, especially the name/title, of the at least one user data object are identified by a particular display, for example by an additional symbol, or by a symbol modified by comparison with the usual symbolic presentation of a file or object type or by changing the display color, brightness or structure to differentiate them from the parameters of other files. I.e. the distinction between so-called normal files and the DRM files and/or the user data objects contained in the DRM-files is made by identifying the parameters of the DRM files and the user data objects in a particular way. Additional symbols or symbols modified by comparison with the normal display of the property parameters of a file or object are especially good for making this distinction. A further possibility is that the property parameters of the DRM files and the user data objects differ in the color of their display, the brightness of the display color, in their display structure etc. from the property parameters of normal files or file objects. For example the property parameters of the DRM files or of the DRM-protected objects can also have a flashing display. The different presentation immediately makes clear to the user in an overview of the memory content or of a memory area which files and objects are the DRM files and/or the user data objects.

It is further advantageous for a number of user data objects of a DRM file to be able to be represented separately as independent objects. In this way the user can immediately recognize a specific data object and where necessary use it with an application. It is also conceivable here for a number of user data objects of a DRM file to be displayed in different ways. This means that the individual user data objects of a DRM file can have different representations as regards their color, their brightness or their structure. The parameters of the individual user data objects can be shown in different ways.

A number of user data objects of a DRM file or the parameters of a number of user data objects of a DRM file can however also be represented by a graphical component, such as for example a bracket or a frame around the user data objects of a DRM file or the parameters of a number of user data objects of a DRM file and/or a common display color, brightness or structure. On the one hand this can indicate which user data objects belong to a DRM file. On the other hand user data objects of a DRM file which belong together can be distinguished from user data objects of other DRM files. The graphical component encloses all the user data objects belonging to a DRM file or all parameters of the user data objects of a DRM file so that the user can immediately recognize which user data objects belong together. This graphical component makes it possible for example for just the user data objects of one DRM file to be shown, without displaying the DRM file itself. The user it still shown which user data objects belong together.

A method is also preferred which makes it possible for at least one user data object to be presented as a subfolder of the DRM folder, for example in the form of a tree structure. This enables the user, when looking at the user surface of the data processing terminal- and/or communication terminal, to see which user data objects belong to which DRM files. The form of a tree structures with a higher-ranking and lower-ranking folders is particularly well suited to this type of presentation. Not only the specific parameters, such as name, type, size, etc. of the DRM file are shown directly to the user but also the individual user data objects belonging to this DRM file or the specific parameters and properties such as name, type, size, usage rights, etc. of these user data objects. A nested form of representation of the memory content or of a memory area, especially for DRM files, represents a simple and clear option for detecting the corresponding files and their subfiles of objects.

It is especially advantageous for an application for managing the usage rights pertaining to a user data object to be integrated into the application for presentation of the memory content or of a memory area on the user surface of a data processing terminal and/or of a communication terminal. When looking at the display of the memory content or of the memory area of the data processing and/or communication terminal the observer additionally obtains the display of the usage rights of the corresponding user data object. If the application for presentation of the memory content or of a memory area is called by the user, the management application, a so-called DRM agent of the usage rights associated with a user data object, runs automatically in the background, so that the usage rights of the individual user data objects are displayed directly with the memory content of the data processing terminal and/or of the communication terminal.

A method is preferred in which, when a user data object is activated the available usage rights are checked and with a positive result the user data object is encrypted and transferred to the corresponding application for usage of the user data object or with a negative result the usage of the user data object is prevented. This is done by a so-called DRM agent. This DRM agent evaluates the control information contained in the DRM file and checks whether the user has the right to use the DRM-protected object in the DRM file. If he does, the DRM agent encrypts the user data object contained in the DRM file and passes this on to an application for processing of the user data object. For the case in which the user does not have the right to use the user data object, the DRM agent prevents a data encryption of the user data object does not pass the user data object on to a corresponding application. Through the integration of management application for the usage rights associated with a user data object, known as the DRM, a check is made as to whether the user is authorized to use the user data object or not. If access to the object is not authorized it prevents access. The integration of the DRM agent makes direct selection of a user data object from the memory system of the data processing terminal and/or of the communication terminal possible and allows immediate activation and usage of the user data object.

It is further advantageous for whether authorization rights exist to the user data object or not to be displayed as further property parameters of the user data object and/or what the type and/or the extent of these user rights are. This type of display makes it possible for the user to obtain an immediate overview of whether usage rights are available at all. A simple presentation can take the form of simply showing the words “yes/no” or id the corresponding usage rights are present this can be presented by a graphical or a text image character, such as an “x” for example. I.e. this simple variant indicates whether there are any valid rights at all present to use a DRM-protected object. A more complex variant comprises a display of the type and/or the scope of the usage rights. For example it can be shown that or whether one or more separate usage rights exist for a DRM-protected object and what type of rights these are. The type of usage rights can for example be a right for a dedicated number of uses of the user data object, the right for a specific usage, as for example “preview only”, “view only and not print” or “view only and not install as background image”.

Furthermore it is preferable for different types of usage rights to be shown by corresponding different graphical and or textual representations. This means that the type of display can be produced graphically by an image symbol varying for a DRM-protected object depending on the available rights or further written or graphical objects can be inserted into the display of the DRM-protected object with which the linked rights are symbolized. This allows the user to recognize directly the type of usage right involved. Different colored representations for an image symbol for a DRM-protected object represent a simple form of display.

Communication terminals are especially taken to mean mobile radio terminals, but also include any other type of communication terminals such as a cordless telephone, a smartphone (combination of small portable computer and mobile telephone), a PDA (Personal Digital Assistant) or an organizer for example. User data objects can involve data in the form of text data, picture data, video data, audio data, executable programs, software components or a combination of these types of data, i.e. multimedia data or content.

The invention further includes a telecommunications arrangement comprising at least one data processing terminal and/or a communication terminal which is arranged for executing a method in accordance with one of the previous claims 1 to 11.

All the details given for the method also relate to the telecommunications arrangement.

Preferred embodiments of the present invention will be explained in more detail below with reference to the enclosed drawings. The figures show:

FIG. 1 a tabular presentation of the content of a memory area of a directory in accordance with the prior art;

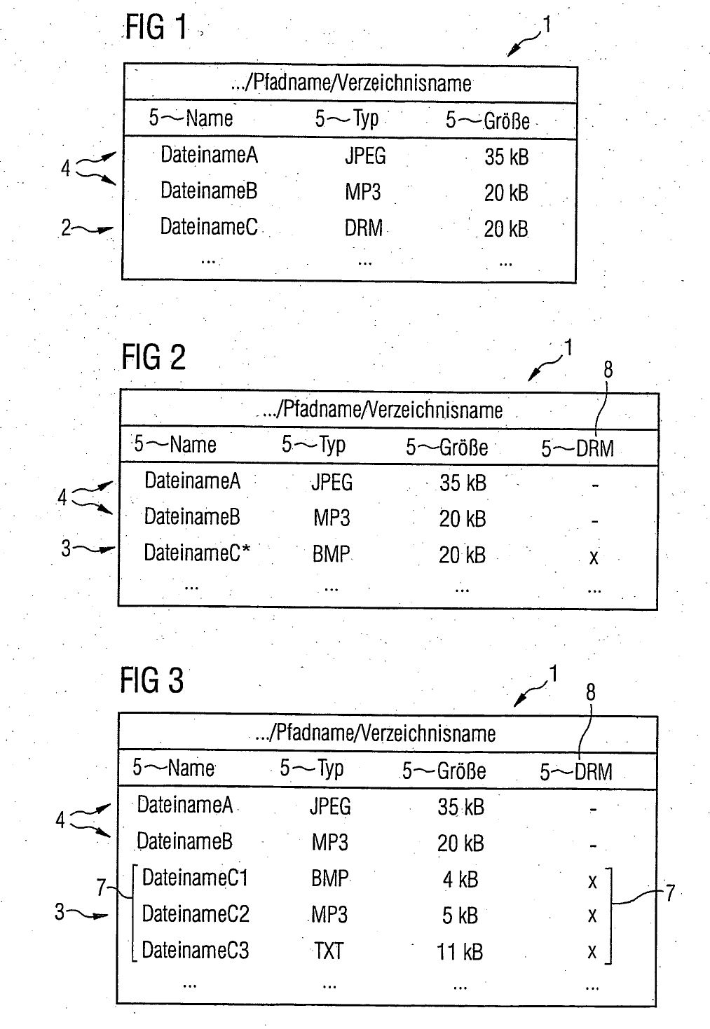

FIG. 2 a tabular presentation of the content of a memory area of a directory with an individual DRM-protected object;

FIG. 3 a tabular presentation of the content of a memory area of a directory with a number of DRM-protected objects which are contained in a DRM file;

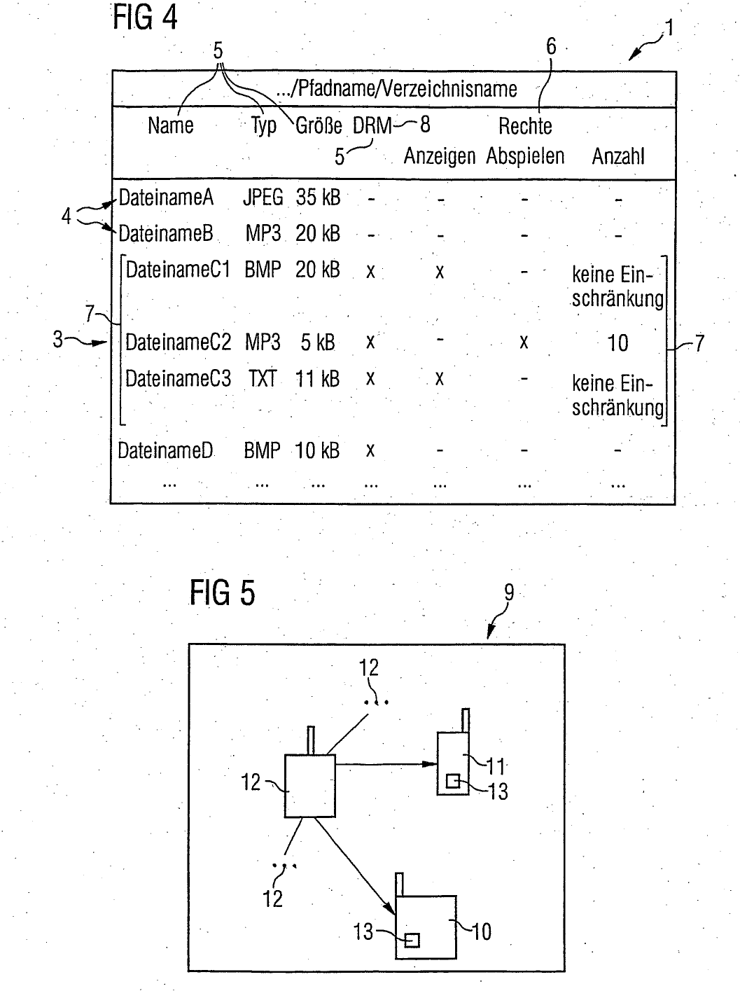

FIG. 4 a tabular presentation of the content of a memory area of a directory with a number of DRM-protected objects, with usage rights of the relevant DRM-protected object being additionally specified;

The following examples illustrate the effects of the invention with reference to the presentation of the memory content or of a memory area of a folder according to the prior art and with different variants of the additional options in accordance with the invention by integration of the DRM functionality into the application for management and presentation of the memory content on the graphical user surface (1).

FIG. 1 shows a tabular presentation of a number of files (2,4) contained in a specific directory (“. . . /pathname/directoryname”). The name, the type and the size (5) of the file is shown explicitly for each file. The user data objects (3) are not shown in this diagram. The only thing that can be seen from this representation known from the prior art is that the file “FilenameC” is a DRM type file (2).

FIG. 2 shows the tabular presentation from FIG. 1 which has been changed in accordance with the invention so that instead of the DRM file (2) or the parameters of the DRM file (2) the DRM-protected object (3) contained in the DRM file (2) is shown or the parameters of the DRM-protected object (3) are shown. Accordingly, in the table shown in FIG. 2 the name of the DRM-protected object (3) “FilenameC*” appears instead of the name of the DRM file (2) “FilenameC”. The file type displayed (5) is that of the DRM-protected object (3) (BMP), the object size (5) differs only insignificantly from the size of the file “FilenameC” and is specified as previously by a rounded figure of 20 kB. As a new element the tabular presentation contains a column (8) which specifies for each object shown whether it is DRM-protected or not. In the present example this is only the case for the object “FilenameC*”.

The table in FIG. 3 typically contains in addition to the picture file (“FilenameA”) and an audio file (“FilenameB”) (4) descriptions of three user data objects (3) which are contained in a DRM file (2). These user data objects (3) have the file names “FilenameC”, “FilenameC2” and “FilenameC” which can generally be chosen at random. The fact that the filenames “FilenameC1”, “FilenameC2” and “FilenameC3” involve DRM-protected objects (3) is also shown, as described in FIG. 2 by an extra column (8). The “X” in the column “DRM” (8) indicates that these are DRM-protected objects (3). In addition all three DRM-protected objects (3) are enclosed by a graphical element (7), in this example two brackets. This shows that the three user data objects (3) belong to a single DRM file (2). Each user data object (3) is described in its turn by its name, its type and its size (5), with the individual user data objects (3) “FilenameC1”, “FilenameC2” and “FilenameC3” featuring different data types.

FIG. 4 shows a tabular presentation of a memory area of a directory of a data processing terminal (10) and/or of the communication terminal (11), with the presentation being expanded from that shown in FIG. 3. The table in FIG. 4, in addition to the basic information as to whether an object is DRM-protected, also shows the type of usage rights (6) linked to a DRM-protected object (3). In FIG. 4 rights are available for the user data objects. (3) “FilenameC1”, “FilenameC2” and “FilenameC3” (6). “FilenameC” and “FilenameC3” can be displayed without restriction, “FilenameC2” can be played 10 times. No rights (6) exist for “FilenameD”. The user data object “FilenameC” cannot currently be used. New rights (6) for using “FilenameC” may be able to be loaded from a server.

The information shown in FIGS. 2 to 4 can alternatively also be represented by icons. For example a sysmbol for the file type, such as e.g. a BMP file, can be added by a small extension in the form of a symbolic padlock for example, which identifies the file as DRM-protected. Further symbols or also variants of the symbol can be employed for presentation of the existing usage rights (6).

FIG. 5 shows a telecommunications arrangement (9) with a number of base stations (12), which transfer user data objects (3) from a switching component not shown to a data processing terminal (10) and a communication terminal (11). The data processing terminal (10) and the communication terminal (11) each feature a microcontroller (13) which is responsible for converting the transmitted user data objects (3) in the terminal (10, 11).

1. Method for managing the memory content or a memory area of a data processing terminal (10) and/or of a communication terminal (11) or for presenting the memory content or a memory area on the user surface (1) of a data processing terminal (10) and/or of a communication terminal
characterized in that
the name or the title of at least one user data object (3) contained in a DRM file is shown directly on the user surface (1) of the data processing terminal (10) and/or of the communication terminal (11) together with the name or the title of the DRM file (2) and/or, if present, with the name or the title of other files (4), for example picture, audio or text files.

2. Method in accordance with claim 1,
characterized in that
the method has the following steps:
Opening the DRM file (2) and reading out basic parameters (5), for example name, type, size, etc., of the at least one user data object;
Displaying at least one of the parameters (5) of the user data object (3) previously read out instead of or in addition to corresponding parameters (5), such as name, type, size, etc., of the DRM file (2) on the user surface (1) of the data processing terminal (10) and/or of the communication terminal (11).

3. Method in accordance with claim 2,
characterized in that
in a further step, usage rights (6)
of the at least one user data object (3) are sought, evaluated and presented in combination with at least the name/title and possibly with the remaining parameters (5) of the corresponding DRM file (2) or of the corresponding user data object (3) on the user surface (1) of the data processing terminal (10) and/or of the communication terminal (11).

4. Method according to claim 1,
characterized in that
the parameters (5), especially the name/title of the DRM file (2) and/or the parameters (5), especially the name/title of the at least one user data object (3) are differentiated from the parameters (5) of other files (4) by a special display, for example by an additional symbol, by an symbol modified from the usual symbolic representation of the parameters (5) of a file or of a user data object or by changing the display color, brightness or structure.

5. Method according to claim 1,
characterized in that
a number of user data objects (3) of a DRM file (2) are shown separately as independent objects.

6. Method according to claim 1,
characterized in that
a number of user data objects (3) of a DRM file (2) or the parameters (5) of a number of user data objects (3) of a DRM file (2) are represented by a graphical component (7), for example a bracket or a frame around the user data objects (3) of a DRM file (2) or around the parameters (5) of a number of user data objects of a DRM file (2) and/or a common display color, brightness or structure.

7. Method according to claim 1,
characterized in that
the at least one user data object (3) is presented as a subfolder of a DRM folder, for example in the form of a tree structure.

8. Method according to claim 1,
characterized in that
an application for managing the usage rights (6) belonging to a user data object (3) is integrated into the application for presentation of the memory content or of a memory area on the user surface (1) of a data processing terminal (10) and/or of a communication terminal (11).

9. Method in accordance with claim 8,
characterized in that
on activation of a user data object (3) the existing usage rights (6) are checked and, with a positive result, the user data object (3) is encrypted and transferred to the corresponding application for usage of the user data object (3) or, with a negative result, the usage of the user data object (3) is prevented.

10. Method in accordance with one of tho claim 2,
characterized in that,
as further property parameter of the user data object (3) it is shown whether usage rights (6) are present for a user data object (3) or not, and/or what the type or the extent of these usage rights (6) is.

11. Method in accordance with claim 10,
characterized in that
different types of usage right (6) are represented by corresponding different graphical and/or textual representations.

12. Telecommunications arrangement (9), comprising at least one data processing terminal (10) and/or a communication terminal (11), which is arranged for executing a method in accordance with claim 1.
